(19) United States
(12) Patent Application Publication
(10) Pub. No.: US 2015/0144706 A1
(43) Pub. Date: May 28, 2015

(54) THERMOSTAT CIRCUITRY TO CONTROL POWER USAGE

(71) Applicant: Honeywell International Inc., Morristown, NJ (US)

(72) Inventors: Kurt Robideau, Zimmerman, MN (US); Patrick R. Lemire, La Prairie (CA); Robert D. Juntunen, Minnetonka, MN (US)

(73) Assignee: Honeywell International Inc., Morristown, NJ (US)

(21) Appl. No.: 14/088,312

(22) Filed: Nov. 22, 2013

(51) Int. Cl. F24F 11/00; G05D 23/19

(52) U.S. Cl. CPC F24F 11/006; G05D 23/1919; F24F 11/0086; F24F 2011/0064; F24F 2011/0071; F24F 2011/0075; F24F 2011/0091
USPC 236/1 C; 236/51; 236/94

(57) ABSTRACT

An operation alteration of a network attached thermostat to control power usage. Control wires for a heating and air conditioning system may be connected to a thermostat control circuit configured to control the system. A power extraction circuit may be coupled to the control wires configured to extract power from the control wires. The power may be put into a storage device. The power may be provided to the thermostat control circuit and a WiFi radio module. The radio module may provide a network connection for the thermostat. Circuitry and techniques may be provided to reduce power usage by the thermostat components.

### BACKGROUND

The present disclosure pertains to thermostats and particularly to circuitry related to thermostats and heating and air conditioning systems.

### SUMMARY

The disclosure reveals an operation alteration of a network attached thermostat to control power usage. Control wires for a heating and air conditioning system may be connected to a thermostat control circuit configured to control the system. A power extraction circuit may be coupled to the control wires configured to extract power from the control wires. The power may be put into a storage device. The power may be provided to the thermostat control circuit and a WiFi radio module. The radio module may provide a network connection for the thermostat. Circuitry and techniques may be provided to reduce power usage by the thermostat components.

### BRIEF DESCRIPTION OF THE DRAWING

FIG. 1 is a diagram of an illustrative example of a thermostat utilizing power extraction and saving features;

FIG. 2 is a diagram of a power extraction circuit;

FIG. 3 is a diagram an illustrative example of the power extraction circuit;

FIG. 4 is a diagram of a table that may illustrate some example conditional situations of the present example of a thermostat system; and

FIG. 5 is a diagram of an illustrative example of a radio module for a thermostat system.

### DESCRIPTION

The present system and approach may incorporate one or more processors, computers, controllers, user interfaces, wireless and/or wire connections, and/or the like, in an implementation described and/or shown herein.

This description may provide one or more illustrative and specific examples or ways of implementing the present system and approach. There may be numerous other examples or ways of implementing the system and approach.

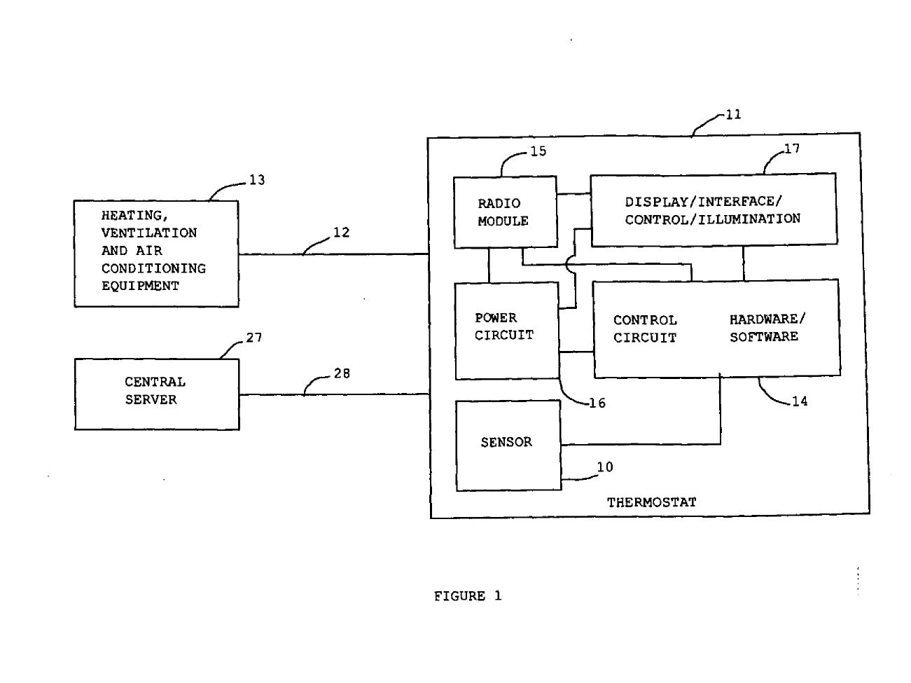

FIG. 1 is a diagram of an illustrative example of a thermostat 11 that may incorporate HVAC control wires 12 for controlling an HVAC system 13, a thermostat control circuit 14 configured to control HVAC system 13, a sensor 10 coupled to thermostat control circuit 14 to provide sensed data, a WiFi radio module 15 coupled to thermostat control circuit 14 to provide a network connection for thermostat 11, and a power circuit 16 coupled to the HVAC control wires 12 for providing power to thermostat control circuit 14, WiFi radio module 15 and display interface 17.

Power circuit 16 may incorporate a power extraction circuit 20 configured to extract power from HVAC control wires 12, a power storage device 21 configured to store electrical current extracted from HVAC control wires 12, common wire detection circuitry configured to detect the presence of a common wire among HVAC control wires 12, a key load determination circuitry configured to determine the electrical load impedance presented by the HVAC equipment in a fast manner, and a key rules table in control circuit 14 correlating the amount of power that can be extracted from HVAC control wires 12 with the load impedances 22, 23, 24 of the HVAC equipment drawing power through one of the impedances.

Display and illumination 17 may be retained on thermostat 11 with circuitry 25 that determines the amount of power stored in power storage device 21.

A communications protocol may be used for communications with the thermostat control circuit 14 and WiFi radio module 15. Messages may be sent using the communications protocol that informs thermostat control circuit 14 and WiFi radio module 15 of power parameters. The power parameters may incorporate presence of a common power terminal or C-wire 26, a charge on the power storage device 21, and an amount of power that can be extracted from HVAC equipment 13.

Common power terminal 26 may be present. A rate of recharge may be input to the logic of control circuit 14 to change behavior of the thermostat display 17 backlight.

Thermostat control circuit 14 may incorporate circuitry configured to control HVAC equipment 13, circuitry to display user information, circuitry to illuminate the device, software that may alter the power used by changing displayed user information and an amount and time of illumination, and a rules table that correlates device operation to several power parameters.

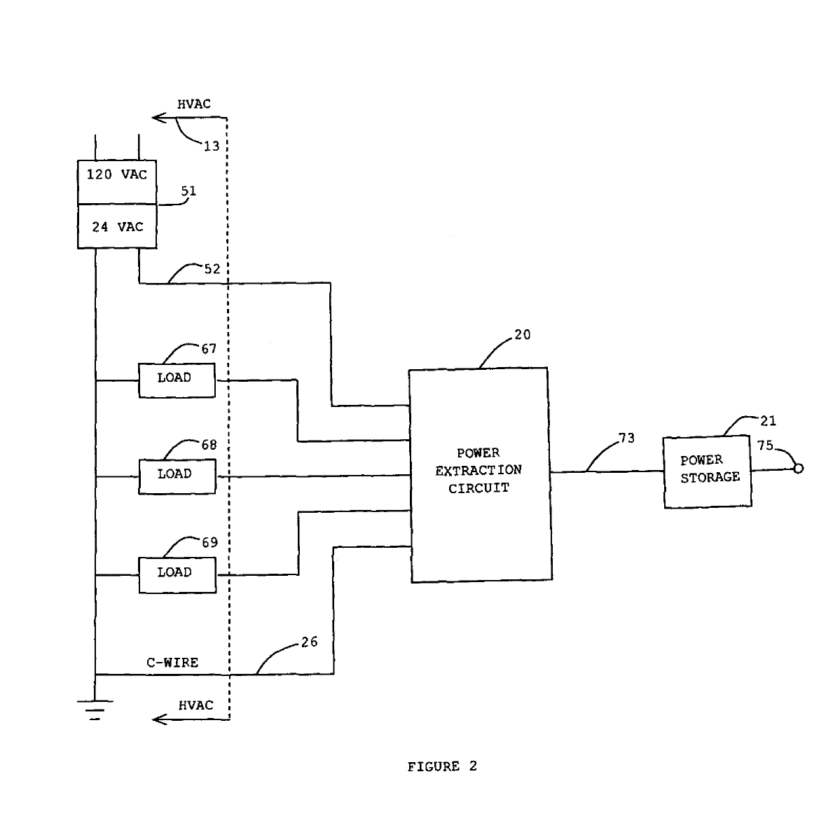

FIG. 2 is a diagram of a power extraction circuit 20 and associated components. Power from a 120 VAC to 24 VAC transformer 51 may be provided on lines 26 and 52 to circuit 20. Power may be extracted from loads 67, 68 and 69 of an example HVAC 13. Other hardware may be implemented in lieu of HVAC 13. An output 73 from circuit 20 may go to a power storage unit 21. Power from unit 21 may be available on output 75.

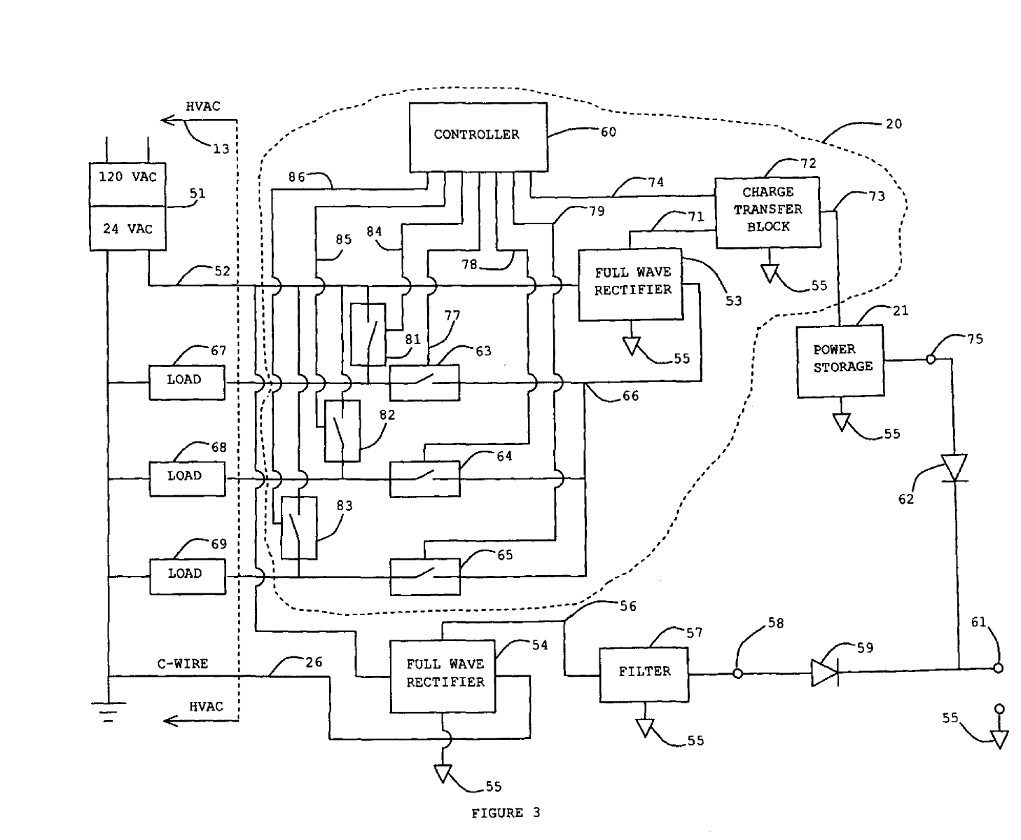

FIG. 3 is a diagram of an illustrative example of power extraction circuit 20 plus several additional components. As noted herein, step-down transformer 51 may provide 24 VAC from line power of 120 VAC. One terminal of the 24 VAC output may be regarded as a C-wire 26 or common line. It may also be regarded as a reference or ground terminal 26. The other terminal of the 24 VAC output may be regarded a hot line or wire 52. Wire 52 may be connected to a first input terminal of a full wave rectifier 53 and a fuel wave rectifier 54. A second input to rectifier 54 may be C-wire 26. One output terminal of rectifier 54 may be connected to a reference voltage ground terminal 55. Another terminal 56 may be connected to an input of a filter 57. Filter 57 may also be connected to ground terminal 55.

An output 58 may go to an anode of a diode 59. A cathode of diode may be connected to an output terminal 61. The output from diode 59 may be noted as power available from a C-wire that is present. Diode 59 may prevent an output from a diode 62 having a higher voltage than the output from diode 59 and overriding output 58. Diodes 59 and 62 may be substituted with switches of one kind or another (e.g., FET switch). In the latter situation, one switch at most may be on though both switches may be off. The switches may be controlled by a controller 60.

In the meanwhile, there may be power transformed from current going through a load of equipment such as HVAC equipment. Terminal 52 may be providing 24 VAC relative to terminal 26 to a first input terminal of rectifier 53. Controller 60 may turn on a relay switch 63 via a line 77. Current may flow through rectifier 53 and out on a conductor 66 and through switch 63 that is closed. The current may flow from switch 63 through a load 67 to C-wire or ground terminal 26 of voltage supply 56.

An output on line 71 may go from rectifier 53 to an input of a charge transfer block 72 relative to ground terminal 55. Current may flow from an output of charge transfer block 72 on a line to an input of a power storage device 21. Device 21 may a super or ultra capacitor or other mechanism for electrical power storage. A transfer of current or charge to storage device 21 may be monitored and/or controlled by controller 60 via a line 74. Detection of an amount of charge or voltage on storage device 21 may be accomplished via line 74 by controller 60.

Power, current at a certain voltage level, may go from an output 75 through diode 62 (anode first) to output 61. As indicated herein, diode 62 may be replaced by a different component such as a FET switch.

In a similar manner as taking power from current going through load 67, power may be taken from current going through loads to 68 and 69. Load switches 64 and 65 for loads 68 and 69, respectively, may be operated by controller 60 via lines 78 and 79. Loads 67, 68 and 69 may be different in terms of impedance. For example, loads 67, 68 and 69 may have impedances of 100, 1,000 and 3,000 ohms, respectively. Load impedances may be other than the noted examples. Switches 63, 64 and 65 as controlled by controller 60 may select an appropriate load from which power is taken and transformed into a charge to be stored in storage device 21.

Rectifier 53 may be bypassed with respect to the current from equipment loads 67, 68 and 69. Relays or switches 81, 82 and 83 may be closed to limit the circuitry of the respective loads across lines 52 and 26. Relays or switches 81, 82 and 83 may be controlled individually by lines 84, 85 and 86 from controller 60 to the relays or switches.

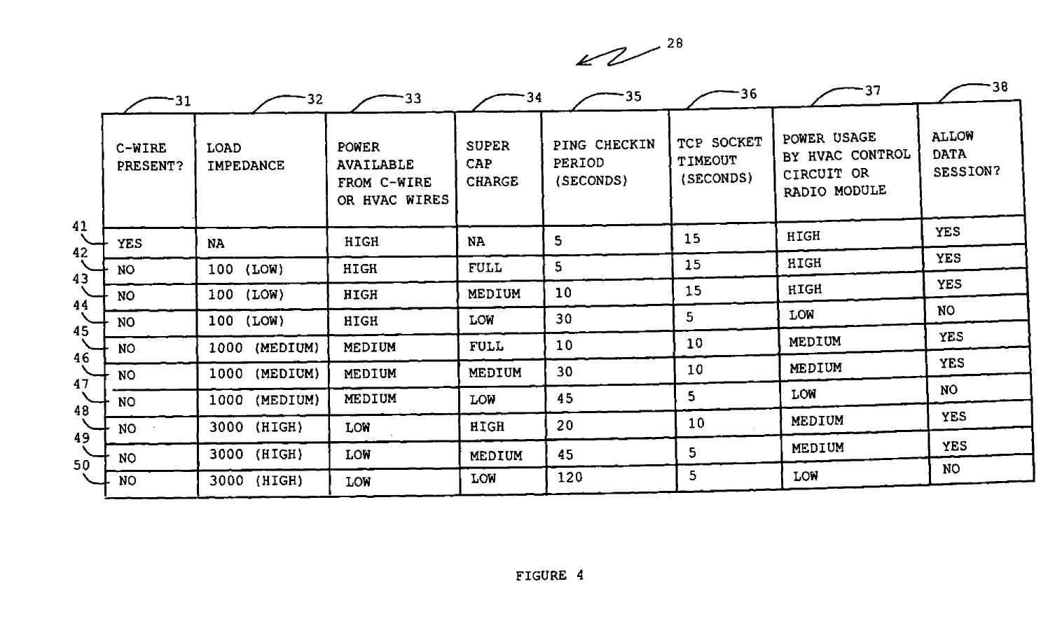

FIG. 4 is a diagram of table 28 that may illustrate some example conditional situations of the present example of a thermostat system. If a common wire 26 is present as indicated by column 31 and row 41, thermostat control circuit 14 may use more power (e.g., more current at a given voltage) as indicated by column 37 and row 41. If common wire 26 is not present, and the amount of power that can be extracted from HVAC control wires 12 is high, then thermostat control circuit 14 may use more power, as indicated by column 37 and rows 42 and 43. If common wire 26 is not present, and the amount of power that can be extracted from HVAC control wires 12 is low, thermostat control circuit 14 may use less power, as indicated by columns 33 and 37 and rows 48-50. If common wire 26 is not present, and the charge on storage device 21 is high, thermostat control circuit 14 may use more power. If common wire 26 is not present, and the charge on storage device 21 is low, thermostat control circuit 14 may use less power, as indicated by columns 34 and 35 and rows 44, 47 and 50.

WiFi radio module 15 may incorporate circuitry configured to communicate with a WiFi router, networking algorithms to communicate through the WiFi router with a central server 27 via a connection 28, software that groups virtually all tasks to be performed in time, software that performs tasks periodically, TCP/IP components that contain networking constants controlling socket timeouts, software that can create network channels to transfer HVAC information between thermostat control circuit 14 and central server 27, software that can abort network communications, software that can alter the power used by changing the task period, networking constants, allowing or disallowing network channels and aborting network communications, and a rules table that correlates device operation to the power parameters (FIG. 1).

If common wire 26 is present, WiFi radio module 15 may use more power. If common wire 26 is not present, and the amount of power that can be extracted from HVAC control wires 12 is high, WiFi radio module 15 may use more power, as indicated by columns 33 and 37 and rows 42 and 43. If common wire 26 is not present, and the amount of power that can be extracted from HVAC control wires 12 is low, WiFi radio module 15 may use less power, as indicated by columns 33 and 37 and row 50. If common wire 26 is not present, and the charge on storage device is high 21, WiFi radio module 15 may use more power, as indicated by columns 34 and 37 and row 42. If common wire 26 is not present, and the charge on storage device 21 is low, WiFi radio module 15 may use less power, as indicated by columns 34 and 37 and row 44, 47 and 50. There may be various approaches for achieving low power on radio module 15.

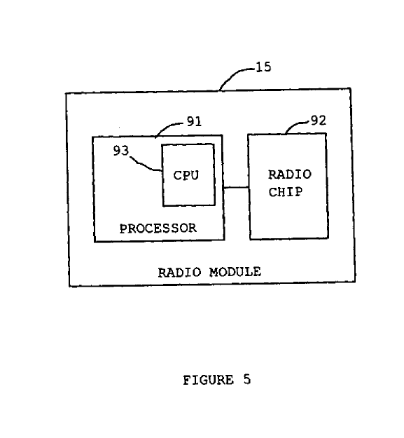

FIG. 5 is a diagram of an illustrative example of a radio module 15 having a processor 91 and a radio chip 92. Radio module 15 may be a WiFi mechanism. Processor 91 may have an ARM core CPU 93 with peripherals provided by a chip vendor. ARM core CPU 93 may have a low power mode. Added to this item may be a low power mode provided by the chip vendor to reduce the power of the processor peripherals when in the stop mode.

Radio chip 92 may have a feature called power save, that reduces power when the radio is idle. A main task of radio module 15 may be to communicate with a server such as server 27. Communication with a server may take several forms. When thermostat data has changed, they may be sent to the server (async data). Periodically, radio module 15 may perform a ping checkin. The ping checkin may be a TCP packet sent to the server. The server may return a packet, which can contain a request for a “data session”.

If a ping checkin contains a data session request, radio module 15 may open a TCP session with the server. Using this socket, the server may transmit data to radio module (and down to thermostat control circuit 14).

A basic technique may be noted. Low power may be achieved in radio module 15 by putting processor 93 into low power mode, and/or radio chip 92 into power save mode, when the application is idle.

The application may use a ThreadX™ (known by Express Logic, Inc.) RTOS. The name “ThreadX” is derived from the fact that threads are used as the executable modules and the letter “X” represents context switching, i.e., it switches threads. Virtually all of the work may be done in threads. The RTOS may run on a “tick”, a 10 ms timer. When the tick occurs, the RTOS may go through the threads and determine which ones are “ready”. The tasks may be executed, with the highest priority ones first.

To determine whether to put radio module 15 into low power mode, a function may go through the tasks on every tick. If none of the tasks are ready, the function may determine when the first task will be ready. If this time exceeds a threshold, the radio module may be put into low power mode for that period of time.

For example, one may assume that the threshold is set to 5 seconds. At tick 1, the tasks are ready. These tasks may be run, radio module 15 may stay awake. At tick 2, the soonest task may be ready in 1 tick. Radio module 15 may stay awake. At tick 3, the soonest task may be ready in 15 seconds. Radio module may be put into a low power mode for 15 seconds.

Background of the technique may be noted. A Broadcom Corporation code may be provided with radio module 15. The code may be called Wiced™. The approach may be known by an Express Logic, Inc., representative (a vendor of ThreadX). Express Logic provided code that could be used to walk through the task table and find the next ready task, as well as code required for keeping the ThreadX kernel time correct.

Task grouping may be noted. In order to allow for longer low power periods, the communication tasks may be combined. During a ping checkin event, async data may be sent to the server. A ping checkin may be performed. If requested, a data session may be opened and data can be transferred from the web to radio module 15.

Altering operation based C-wire 26, load and available power may be noted. Power extraction circuit 20 may provide power to radio module 15. Circuit 20 may provide several pieces of information to radio module 15 which can be used to alter the operation of the radio module 15.

If C-wire 26 is present, the device is not necessarily power limited. If C-wire 26 is not present, the device may be power limited. Power extraction circuit 20 may draw full power from a 24 volt line when the furnace/AC is on (load on), and steal a small amount of power when the furnace/AC is off (load off).

The amount of power that circuit 20 can draw when in the load off mode may be a function of the load impedance (e.g., resistance). Low load impedance may allow a (relatively) high power draw from the load with the furnace/AC is off. High load impedance may allow a lower power draw.

As an illustrative example, one may assume that the circuit 20 may apply a voltage across the load of 3 volts. A traditional relay based furnace may present a load impedance of 100 ohms. Power extraction circuit 20 may steal 3/100=30 mA. If a zone panel presents a load impedance of 3000 ohms, circuit 20 may steal 3/3000=1 mA.

Power extraction circuit 20 may store energy in a storage device such as a super capacitor 21. When depleted, capacitor 21 may be charged from power taken from the load. Circuit 20 may report the charge on super capacitor 20 to radio module 15.

Using these pieces of information, radio module 15 may change its behavior. Certain key parameters that affect power usage may be varied, such as a ping checkin period, TCP socket timeouts, and whether to accept data session requests.

Basic rules may incorporate the following items as may be guided by table 28 of FIG. 4. If C-wire is present, a device such as radio module 15 may run at optimal settings. If a load has high impedance, radio module 15 may know that a super capacitor charge rate will be slow. Radio module 15 may be rather conservative with its power settings. If the load has low impedance, the charge rate may be higher and thus more aggressive power settings of radio module 15 may be used. If the charge on super capacitor 21 is high, aggressive power settings of radio module may be used. If the charge is low, conservative settings of radio module may be used.

FIG. 4 is a diagram of table 28 showing examples of power usage. If power is low, transmission by radio module 15 may be aborted. While performing the communication tasks, radio module 15 may check with circuit 20 at key points to see if the power available has dropped to a critically low level. If so, the communication tasks may be aborted.

Thermostat data may be buffered while radio module 15 is in a low power mode. When radio module 15 is in the low power mode, and thermostat data changes, the following sequence may be followed. Thermostat 11 may assert an IO line to wake up radio module 15. Thermostat 11 may send the data to radio module 15. Radio module 15 may time-stamp the data, buffer (store) the data, and then go back into the low power mode. When radio module 15 wakes up for scheduled transmission tasks, radio module 15 may send buffered data.

A network attached thermostat 11 with illumination and a user display may consume significant power. When the same thermostat 11 draws that power from a power extraction circuit, the available power may be limited. If thermostat 11 draws too much power, the illumination, display and network connection may be turned off. The present approach may avoid this issue by having extended knowledge of an ability of the power extraction circuit to provide power based on the particular HVAC equipment 13 installed. In addition, thermostat 11 may be designed to operate within that available power. In this manner, thermostat 11 may avoid having to turn off the illumination, display and network connection due to excessive power usage.

To recap, a thermostat may incorporate control wires that control heating, ventilation and air conditioning (HVAC) equipment, a thermostat control circuit configured to control the HVAC equipment, a radio module coupled to the thermostat control circuit to provide a network connection for the thermostat, and a power circuit system coupled to the control wires and providing power to the thermostat control circuit and the radio module.

The power circuit system may incorporate an extraction circuit configured to extract power from the control wires, a power storage device configured to store electrical current extracted from the control wires, common wire detection circuitry configured to detect a presence of a common wire among the control wires, and load determination circuitry configured to determine the electrical load impedance presented by HVAC equipment.

The power circuit system may further incorporate a rules table correlating the amount of power that can be extracted from the control wires with the load impedance of the HVAC equipment for determining the amount of power stored in the power storage device, and a communications protocol used for communications with the thermostat control circuit and the radio module. Messages are sent using the communications protocol that informs the thermostat control circuit and radio module of power parameters incorporating presence of the common wire, a charge on the power storage device and an amount of power that can be extracted from the HVAC equipment.

The thermostat control circuit may incorporate circuitry configured to control the HVAC equipment, a display, circuitry configured to show user information on the display, circuitry configured to illuminate the display, software configured to alter power used by changing the user information and an amount and time of illumination of the display, and a rules table that correlates thermostat operation to power parameters.

The rules table may incorporate one or more statements or items of a group consisting of: if the common wire is present, the thermostat control circuit uses more power than if the common wire is absent; if the common wire is absent, and the amount of power that can be extracted from the control wires is high, the thermostat control circuit uses more power than when the amount of power that can be extracted from the control wires is normal; if the common wire is absent, and the amount of power than that can be extracted from the control wires is low, the thermostat control circuit uses less power than when the amount of power that can be extracted from the control wires is normal; if the common wire is absent, and the charge on the power storage device is high, the thermostat control circuit uses more power than when the charge on the power storage device is normal; and/or if the common wire is absent present, and the charge on the power storage device is low, the thermostat control circuit uses less power than when the charge on the power storage device is normal. High may be greater than normal and normal may be greater than low.

The radio module may incorporate circuitry configured to communicate with a WiFi router, networking algorithms to communication through the WiFi router with a central server, software configured to group virtually all tasks to be performed in time, software configured to perform tasks periodically, TCP/IP configured to contain networking constants that control socket timeouts, software configured to create network channels for transfer of HVAC information between the thermostat control circuit and the central server, software configured to abort network communications, software configured to alter the power used by changing the task period, networking constants, allowing or disallowing network channels and aborting network communications, and/or a rules table that correlates thermostat operation to power parameters.

The rules table may incorporate one or more statements or items of a group consisting of: if the common wire is present, the WiFi radio module uses more power than if the common wire is absent; if the common wire is not present, and the amount of power that can be extracted from the control wires is high, the WiFi radio module uses more power than when the amount of power is normal; if the common wire is not present, and the amount of power that can be extracted from the control wires is low, the WiFi radio module uses less power than when the amount of power that can be extracted from the control wires is normal; if the common wire is not present, and the charge on the power storage device is high, the WiFi radio module uses more power than when the charge on the power storage device is normal; and if the common wire is not present, and the charge on the power storage device is low, the WiFi radio module uses less power than when the charge on the power storage is normal. High may be greater than normal and normal may be greater than low.

An approach for altering operation of a network attached thermostat to control power usage, may incorporate providing a thermostat for controlling HVAC equipment. The thermostat may incorporate a radio module, a power circuit, and a control circuit. The radio module may incorporate a processor and radio chip.

The approach may further incorporate reducing power of the processor peripherals with a stop mode of the processor, reducing power of the radio chip with a power save feature, and communicating with a server having the radio module.

The approach may further incorporate communicating with a server using the radio module. Communicating with the server may incorporate that when thermostat data have changed the data are sent to the server, a data session is had with the server, or there is a performance of a ping check-in as a TCP packet sent to the server.

The approach may further incorporate putting the processor into a stop mode and the radio chip into a power save mode to reduce power in the radio module when an application is idle.

The approach may further incorporate providing power from the power circuit to the radio module. The power circuit may draw a first amount of power from a voltage line when the HVAC equipment is on. The power circuit may extract a second amount of power when the HVAC equipment is off. The first amount of power may be greater than the second amount of power.

The second amount of power that the power circuit can extract may vary inversely with a load impedance with the HVAC equipment off.

The approach may further incorporate using the second amount of power to provide a charge to a super capacitor. The charge on the super capacitor may be available as power for the radio module.

A thermostat system may incorporate a power supply circuit configured for connection to heating, ventilation and air conditioning (HVAC) equipment, a control circuit connected to the power supply circuit, a radio module connected to the control circuit, and a sensor connected to the control circuit. The power supply circuit may incorporate a power extraction circuit having an output. The power extraction circuit may obtain power for the output from current through a load impedance of HVAC equipment.

The power extraction circuit may further incorporate a presence of a common power source wire that prevents the output from being necessarily limited in power. An absence of the common power source wire may cause the output to be limited in power from current through the load impedance of the HVAC equipment in an off mode, and from an amount of charge on a super capacitor. The amount of charge on the super capacitor may be obtained from current through the load impedance of the HVAC equipment in the off mode.

The radio module may incorporate a processor and a radio chip. The processor may have a stop mode. The radio chip may have a power save mode. Power consumption by the radio module may be reduced to a low power mode when the processor is in a stop mode or the radio chip is in a power save mode.

If the radio module is in the low power mode and thermostat data are new or vary, then the control circuit may wake up the radio module from the low power mode, and send the thermostat data to the radio module. The radio module may receive and store the thermostat data, and then return to the low power mode. The radio module may wake up for a scheduled transmission task and send the stored data to a predetermined destination.

Communication tasks of the radio module may be combined for increasing a period of the low power mode. The communication tasks may incorporate sending asynchronous data to a server and performing a ping check-in. If a data session is requested in the ping check-in, a data session may be opened and data be transferred from a server to the radio module.

The system may further incorporate a display. The display may incorporate illumination and a network connection that consumes a minimum amount of power. The minimum amount of power may be available from the power extraction circuit to prevent the display, the illumination, or the network connection from being turned-off.

In the present specification, some of the matter may be of a hypothetical or prophetic nature although stated in another manner or tense.

Although the present system and/or approach has been described with respect to at least one illustrative example, many variations and modifications will become apparent to those skilled in the art upon reading the specification. It is therefore the intention that the appended claims be interpreted as broadly as possible in view of the related art to include all such variations and modifications.

What is claimed is:

1. A thermostat comprising:
control wires that control heating, ventilation and air conditioning (HVAC) equipment;
a thermostat control circuit configured to control the HVAC equipment;
a radio module coupled to the thermostat control circuit to provide a network connection for the thermostat; and
a power circuit system coupled to the control wires and providing power to the thermostat control circuit and the radio module; and
wherein the power circuit system comprises:
an extraction circuit configured to extract power from the control wires;
a power storage device configured to store electrical current extracted from the control wires;
common wire detection circuitry configured to detect a presence of a common wire among the control wires; and
load determination circuitry configured to determine the electrical load impedance presented by HVAC equipment.

2. The thermostat of claim 1, wherein the power circuit system further comprises:
a rules table correlating the amount of power that can be extracted from the control wires with the load impedance of the HVAC equipment for determining the amount of power stored in the power storage device; and
a communications protocol used for communications with the thermostat control circuit and the radio module; and
wherein messages are sent using the communications protocol that informs the thermostat control circuit and radio module of power parameters incorporating presence of the common wire, a charge on the power storage device and an amount of power that can be extracted from the HVAC equipment.

3. The thermostat of claim 1, wherein the thermostat control circuit comprises:
circuitry configured to control the HVAC equipment;
a display;
circuitry configured to show user information on the display;
circuitry configured to illuminate the display;
software configured to alter power used by changing the user information and an amount and time of illumination of the display; and
a rules table that correlates thermostat operation to power parameters.

4. The thermostat of claim 3, wherein the rules table comprises one or more statements of a group consisting of:
if the common wire is present, the thermostat control circuit uses more power than if the common wire is absent;
if the common wire is absent, and the amount of power that can be extracted from the control wires is high, the thermostat control circuit uses more power than when the amount of power that can be extracted from the control wires is normal;
if the common wire is absent, and the amount of power that can be extracted from the control wires is low, the thermostat control circuit uses less power than when the amount of power that can be extracted from the control wires is normal;
if the common wire is absent, and the charge on the power storage device is high, the thermostat control circuit uses more power than when the charge on the power storage device is normal; and
if the common wire is absent present, and the charge on the power storage device is low, the thermostat control circuit uses less power than when the charge on the power storage device is normal; and
wherein high is greater than normal and normal is greater than low.

5. The thermostat of claim 1, wherein the radio module comprises:
circuitry configured to communicate with a WiFi router;
networking algorithms to communication through the WiFi router with a central server;
software configured to group virtually all tasks to be performed in time;
software configured to perform tasks periodically;
TCP/IP configured to contain networking constants that control socket timeouts;
software configured to create network channels for transfer of HVAC information between the thermostat control circuit and the central server;
software configured to abort network communications;
software configured to alter the power used by changing the task period, networking constants, allowing or disallowing network channels and aborting network communications; and
a rules table that correlates thermostat operation to power parameters.

6. The thermostat of claim 5, wherein the rules table comprises one or more statements of a group consisting of:
if the common wire is present, the WiFi radio module uses more power than if the common wire is absent;
if the common wire is not present, and the amount of power that can be extracted from the control wires is high, the WiFi radio module uses more power than when the amount of power is normal;
if the common wire is not present, and the amount of power that can be extracted from the control wires is low, the WiFi radio module uses less power than when the amount of power that can be extracted from the control wires is normal;
if the common wire is not present, and the charge on the power storage device is high, the WiFi radio module uses more power than when the charge on the power storage device is normal;
if the common wire is not present, and the charge on the power storage device is low, the WiFi radio module uses less power than when the charge on the power storage is normal; and
high is greater than normal and normal is greater than low.

7. A method for altering operation of a network attached thermostat to control power usage, comprising:
providing a thermostat for controlling HVAC equipment; and
wherein:
the thermostat comprises a radio module, a power circuit, and a control circuit; and
the radio module comprises a processor and radio chip.

8. The method of claim 7, further comprising:
reducing power of the processor peripherals with a stop mode of the processor;
reducing power of the radio chip with a power save feature; and
communicating with a server having the radio module.

9. The method of claim 7, further comprising:
communicating with a server using the radio module; and
wherein:
communicating with the server comprises:
when thermostat data have changed, the data are sent to the server;
a data session is had with the server; or
there is a performance of a ping check-in as a TCP packet sent to the server.

10. The method of claim 7, further comprising putting the processor into a stop mode and the radio chip into a power save mode to reduce power in the radio module when an application is idle.

11. The method of claim 7, further comprising:
providing power from the power circuit to the radio module; and
wherein:
the power circuit draws a first amount of power from a voltage line when the HVAC equipment is on;
the power circuit extracts a second amount of power when the HVAC equipment is off; and
the first amount of power is greater than the second amount of power.

12. The method of claim 11, wherein the second amount of power that the power circuit can extract varies inversely with a load impedance with the HVAC equipment off.

13. The method of claim 12, further comprising:
using the second amount of power to provide a charge to a super capacitor; and
wherein the charge on the super capacitor is available as power for the radio module.

14. A thermostat system comprising:
a power supply circuit configured for connection to heating, ventilation and air conditioning (HVAC) equipment;
a control circuit connected to the power supply circuit;
a radio module connected to the control circuit; and
a sensor connected to the control circuit.
wherein:
the power supply circuit comprises a power extraction circuit having an output; and
the power extraction circuit can obtain power for the output from current through a load impedance of an HVAC equipment.

15. The system of claim 14, the power extraction circuit further comprises:
a presence of a common power source wire that prevents the output from being necessarily limited in power; and
wherein:
an absence of the common power source wire causes the output to be limited in power from current through the load impedance of the HVAC equipment in an off mode, and from an amount of charge on a super capacitor; and
the amount of charge on the super capacitor is obtained from current through the load impedance of the HVAC equipment in the off mode.

16. The system of claim 14, wherein the radio module comprises:
a processor; and
a radio chip; and
wherein:
the processor has a stop mode;
the radio chip has a power save mode; and
power consumption by the radio module is reduced to a low power mode when the processor is in a stop mode or the radio chip is in a power save mode.

17. The system of claim 16, wherein:
if the radio module is in the low power mode and thermostat data are new or vary, then the control circuit wakes up the radio module from the low power mode, and sends the thermostat data to the radio module;
the radio module receives and stores the thermostat data, and then returns to the low power mode; and
the radio module wakes up for a scheduled transmission task and sends the stored data to a predetermined destination.

18. The system of claim 16, wherein communication tasks of the radio module are combined for increasing a period of the low power mode.

19. The system of claim 18, wherein:
the communication tasks comprise:
sending asynchronous data to a server; and
performing a ping check-in; and
if a data session is requested in the ping check-in, a data session is opened and data are transferred from a server to the radio module.

20. The system of claim 14, further comprising:
a display; and
wherein:
the display comprises illumination and a network connection that consumes a minimum amount of power; and
the minimum amount of power is available from the power extraction circuit to prevent the display, the illumination, or the network connection from being turned-off.
